(19) United States
(12) Patent Application Publication
(10) Pub. No.: US 2024/0419730 A1
(43) Pub. Date: Dec. 19, 2024

(54) Podcast And Radio Programming Recommendations Based On OTA Radio Broadcast Listening

(71) Applicant: iBiquity Digital Corporation, Columbia, MD (US)

(72) Inventors: Paul Venezia, Keene, NH (US); Robert M. Dillon, Mendham, NJ (US); Christopher Ambrozic, Chapel Hill, NC (US); Allen Schrott, Ann Arbor, MI (US)

(21) Appl. No.: 18/745,500

(22) Filed: Jun. 17, 2024

Related U.S. Application Data
(60) Provisional application No. 63/508,448, filed on Jun. 15, 2023.

(51) Int. Cl. G06F 16/638; G10L 15/08

(52) U.S. Cl. CPC G06F 16/639; G10L 15/08; G10L 2015/088

(57) ABSTRACT

Generally disclosed herein is a mechanism to automatically recommend radio stations, audio content, or URLs for additional audio content based on analysis of the user's current and past listening activities and the program information of the radio stations received by the user device. The user's preference for particular topics or themes for particular additional audio content can be determined based on the user's historical or preference data. Such topics or themes can also be determined using machine learning models in real time or near real time while the user is listening to particular audio content. Based on the time and day when the user's listening activities occurred, time-specific recommendations for other audio content or radio stations can be output, such as through a display of the user's device.

### CROSS-REFERENCE TO RELATED APPLICATIONS

This application claims the benefit of the filing date of U.S. Provisional Patent Application No. 63/508,448 filed Jun. 15, 2023, the disclosure of which is hereby incorporated herein by reference.

### BACKGROUND

Over-the-air (OTA) radio broadcast signals can be used to deliver a variety of programming content to radio receiver systems. Over-the-air radio broadcast signals include conventional amplitude-modulated (AM) and frequency-modulated (FM) analog broadcast signals, digital radio broadcast signals or other broadcast signals. Digital radio broadcast signals can deliver digital audio and data services to the radio receiver systems. Users may tune the radio receivers to a variety of radio stations, including analog and digital broadcasts, for particular radio programs. Typically, each radio station broadcasts different radio programs such as radio shows at different times, with each program focusing on a particular topic or theme.

After the users listen to radio talk shows or news, the users may become interested in searching for and listening to supplemental audio content such as podcasts that focus on similar topics on the Internet or other radio stations. However, since there are overwhelming amounts of audio content available on the Internet and/or radio stations, it can be difficult for the users to find quickly the appropriate audio content corresponding to the topics that the users are interested in.

### BRIEF SUMMARY

Generally disclosed herein is a mechanism to provide audio content and radio station recommendations based on analyzing the content of the audio content that a user listens to over a particular time period. Machine learning models may be trained to identify particular topics or themes of the audio content. Recommendations of different audio content and/or local radio stations may be generated based on the identified topic and or themes. For example, other radio programs, such as a talk show focusing on a similar topic, may be recommended based on program information related to the radio stations received by the user device. In some examples, the recommendations may be based on other factors, such as user actions relative to the received content. For example, if the user adjusted the controls to increase the volume during a particular portion of a radio program received at the user device, it may be determined that the content of the radio program during that time is of particular interest to the user. Hyperlinks directed to additional audio content, such as podcasts, that discusses topics similar to the identified topic can also be identified and output to the user device.

An aspect of the disclosure provides a system for audio content and radio programming recommendations. The system comprises one or more memories and one or more processors in communication with the one or more memories, the one or more processors configured to determine one or more radio stations receivable by a user device, detect a user listening activity, identify one or more keywords associated with first audio content broadcast by a first radio station during the detected user listening activity, generate a recommendation for second audio content based on the identified one or more keywords associated with the first audio content, and output the generated recommendation to the user device.

In an example, the one or more processors are further configured to identify one or more t uniform resource locators (URLs) to access the second audio content.

In another example, the second audio content comprises a podcast, talk show, news program, or visual content.

In yet another example, the user listening activity includes tuning the user device to a first broadcast channel for the first radio station or remaining on the first broadcast channel for a threshold time period.

In yet another example, the one or more processors are further configured to retrieve metadata of the first audio content from a database and transmit the metadata to the user device, wherein the metadata includes information related to a subject, host, or date of broadcast.

In yet another example, the one or more processors are further configured to determine the preference data or historical data for a user based on one or more previous listening activities for the user, and generate the recommendation based on the determined user's preference data or historical data.

In yet another example, generating the recommendation comprises generating a recommendation for the second audio content based on information related to a host associated with the first audio content.

In yet another example, the one or more processors are further configured to receive a request from the user for a customized recommendation using the user device.

In yet another example, the one or more keywords associated with first audio content is identified using a machine learning model.

In yet another example, the one or more processors are further configured to receive feedback on the generated recommendation and update the machine learning model based on the received feedback using the user device.

In yet another example, the one or more keywords associated with the first audio content broadcast by the first radio station are identified based on semantic keyword identifications derived from post-processing a previously recorded broadcast of the first audio content.

Another aspect of the disclosure provides a method for audio content and radio programming recommendations. The method comprises determining one or more radio stations receivable by a user device, detecting a user listening event, identifying one or more keywords associated with first audio content broadcast by a first radio station during the detected user listening activity, generating a recommendation for second audio content based on the identified one or more keywords associated with the first audio content, and outputting the generated recommendation to the user device.

In an example, the method further comprises identifying one or more Internet URLs to access the second audio content.

In another example, the second audio content comprises a podcast, talk show, news program, or visual content.

In yet another example, the user listening activity includes tuning the user device to a first broadcast channel for the first radio station or remaining on the first broadcast channel for a threshold time period.

In yet another example, the method further comprises retrieving metadata of the first audio content from a database and transmitting the metadata to the user device, wherein the metadata includes information related to a subject, host, or date of broadcast.

In yet another example, the method further comprises determining the preference data or historical data for a user based on one or more previous listening activities for the user, and generating the recommendation based on the determined user's preference data or historical data.

In yet another example, generating the recommendation comprises generating a recommendation for the second audio content based on information related to a host associated with the first audio content.

In yet another example, the method further comprises receiving a request from the user for a customized recommendation using the user device.

In yet another example, the one or more keywords associated with first audio content is identified using a machine learning model.

### BRIEF DESCRIPTION OF THE DRAWINGS

FIG. 1 depicts diagrams illustrating an example system for providing audio content and radio programming recommendations associated with over-the-air radio broadcast signals according to aspects of the disclosure.

FIG. 2 depicts a block diagram illustrating example components of audio content and radio programming recommendation system according to aspects of the disclosure.

FIG. 3 depicts a block diagram illustrating an example radio receiver according to aspects of the disclosure.

FIG. 4 depicts a block diagram illustrating an example server system according to aspects of the disclosure.

FIG. 5 depicts a flow diagram illustrating an example audio content and radio programming recommendation process according to aspects of the disclosure.

### DETAILED DESCRIPTION

The present disclosure provides a system and method for automatically recommending radio stations, audio content, or uniform resource locators (URLs) for additional audio content based on analysis of the user's current and past listening activities and the program information of the radio stations received by the user device. The user's preference for particular topics or themes for particular additional audio content can be determined based on the user's historical or preference data. Such topics or themes can also be determined using machine learning models in real time or near real time while the user is listening to particular audio content. Based on the time and day when the user's listening activities occurred, time-specific recommendations for other audio content or radio stations can be output, such as through a display of the user's device.

The system may collect data related to the programs that radio stations broadcast on certain days at certain times. Since each radio station may produce different programs and change the programs unbeknownst to the user, the system may monitor any changes in the schedule and the content of programs that each radio station produces and broadcasts. The system may also monitor the program content received by the user device. Using the collected data to determine specific content that was received by the user device, the system may determine other content recommended for the user. For example, the system may determine that the user was listening to station A at a given time, based on signals received at the user's device during the given time. The system may also determine, based on the collected data, the content that was being broadcast by station A during the given time. By analyzing the content, the system may determine user preferences. In some examples, such preferences may be gathered at multiple points in time from different content received by the user device, and such preferences may be used to generate a user profile. Based on the preferences, other content (e.g., other programs with similar attributes) can be recommended to the user. For example, if the system detects that the user device received a radio program discussing a specific topic, the system can recommend podcasts or other content discussing that specific topic.

In some examples, the system may use machine learning models embedded in computing servers to determine particular topics or themes of the audio content received by the user device. For example, the machine learning models can be trained to detect specific keywords using speech recognition techniques, and to compare the identified keywords to known content taxonomy which can provide a common language that can be used when describing particular audio content. The system may generate a list of recommended audio content broadcast by other radio stations receivable by the user device at the time of the recommendation. Additionally, or alternatively, the system may determine hyperlinks such as IP addresses that can be used to access additional audio content on the Internet. The machine learning models may be refined based on user feedback related to the generated recommendations. For example, the system can monitor whether the user selects audio content included in the generated recommendations and update the machine learning models based on the user's selection.

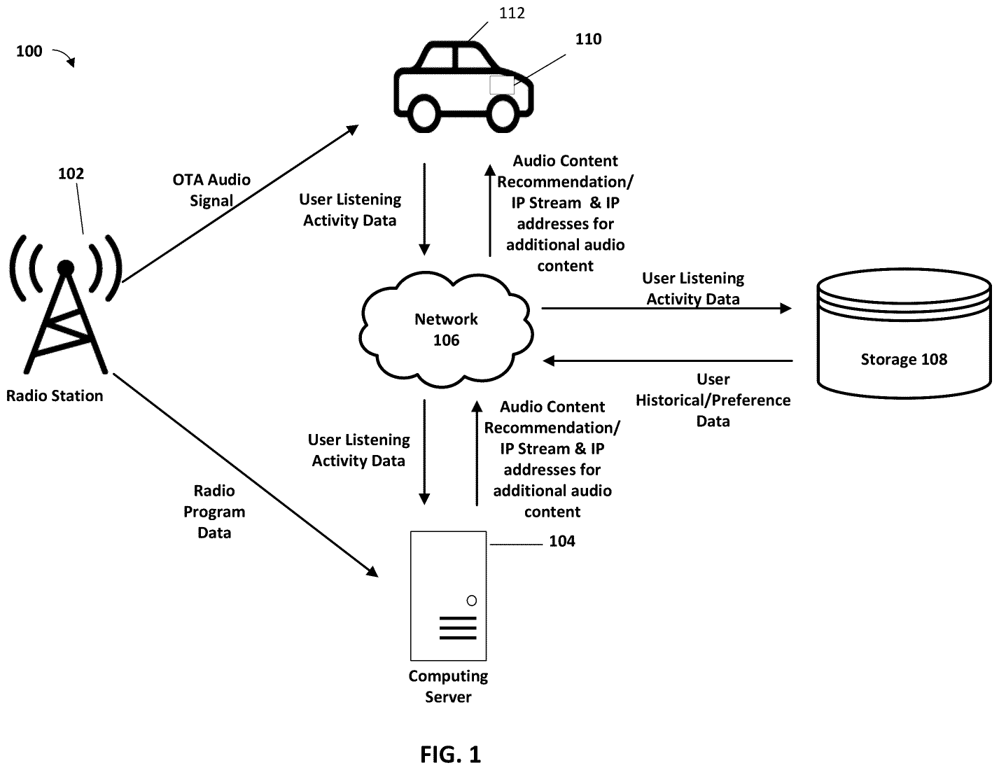

FIG. 1 depicts a block diagram illustrating an example system for providing audio content and radio programming recommendations associated with over-the-air radio broadcast signals. The audio content may include music, talk shows, podcasts, news, etc. The audio content and radio programming recommendations system 100 may generate recommendations for additional audio content based on the topic or theme of the current audio content broadcast by radio station 102 to radio receiver 110. While one radio station 102 is shown, it is to be understood that multiple radio stations can broadcast audio content to any number of user devices. Computing server 104 may continually identify a list of radio stations receivable by radio receiver 110 based on the geographic location of radio receiver 110 and receive the program information associated with the audio content available from each radio station receivable by radio receiver 110 at particular times at particular geographic locations.

The audio content and radio programming recommendation system 100 may include radio station 102, computing servers 104, and storage 108. Radio station 102 may transmit an OTA audio signal to radio receiver 110. Radio station 102 may send radio program data to computer servers 104. Radio receiver 110 may send user listening activity data to computing servers 104 via network 105. User listening activity data may include data related to the radio station that the radio receiver 110 is tuned to, radio content that the user is currently listening to, timestamp data recorded when the user is listening to particular radio content, location data where the user is listening, etc. The user listening activity data may also include information as to whether the user is tuning the user device to a particular broadcast channel for a particular radio station or remaining on the broadcast channel for a threshold time period.

Radio receiver 110 may receive audio content and/or radio station recommendations from computing server 104 via network 105. Radio receiver 110 may also receive hyperlinks to additional podcast content from computing server 104. Such listening activity data can be stored in storage 108 via network 106. Computing servers 104 can receive user historical or preference data from storage 108 and use such data to generate additional audio content or radio station recommendations, which are provided to the radio receiver 110.

Radio station 102 may include a traditional broadcast radio stations or any types of radio transmitter system that can transmit an OTA audio signal. The OTA audio signal may include an analog audio signal, a digital audio signal, or a hybrid audio signal

Radio receiver 110 may include a tuner that can tune into a radio station. Radio receiver 110 may receive the OTA audio signal from radio station 102. Radio receiver 110 may also receive IP-delivered content from computing server 104. The IP-delivered content may include dynamic metadata such as information related to the hosts of the podcasts, subject matters or topics of the podcasts, on-air radio program information, and any other audio content information broadcast by radio station 102.

Radio receiver 110 may be a hand-held device such as a tablet, laptop, smartphone, or smart wearable that includes hardware and/or software for both receiving IP-delivered content via wireless IP and a radio receiver comprising radio chipset and associated antenna systems. Radio receiver 110 may be included in vehicle 112 or may include a smartphone that can receive the IP-delivered content. The smartphone may be physically, or wirelessly linked to the vehicle 112. Radio receiver 110 may also transmit user listening activity data to computing server 104 via network 106. Radio receiver 110 may send the user listening activity data via network 106 to storage 108.

Computing server 104 may receive and analyze the radio program data from radio station 102. The radio program data may include information about the programs of radio station 102. Such information may include data about the podcasts, topics, hosts, other available radio programs related to similar topics that radio station 102 produces and broadcasts. The radio program data may also include data about the programs that radio station 102 produced in the past. Computing server 104 may receive radio program data from a plurality of radio stations. Computing server 104 may determine specific time windows when radio station 102 broadcasts particular audio content. For example, computing server 104 may determine when a classical music station broadcasts a program about the history of jazz music on a particular day of the week at a particular time.

Computing server 104 may transmit IP stream to radio receiver 110. The IP stream may include the IP-delivered content such as dynamic metadata such as artistic information, song titles, on-air radio program information, and station content information associated with radio station 102 or static metadata such as slogan, logo, and name of radio station 102. IP stream may also include access information associated with the radio streaming service that radio station 102 may provide over the Internet. For example, the user may tune radio receiver 110 into radio station 102 and receive IP streaming information from computing server 104 via a hyperlink or QR code shown on a display of radio receiver 110 such that the user may later access particular radio content that radio station 102 broadcasts through Internet streaming using the user's smartphone, laptop or smartwatch. Such IP streaming information may also include hyperlinks for additional audio content such as second or third episodes of the podcast or radio show that the user is currently listening to.

Computing server 104 may recommend the above radio station to the user who likes to listen to podcasts centered around similar topics only at the above-mentioned particular time. Computing server 104 may store the current listening activity data as the user's historical or preference data in storage 108 for future use. Computing server 104 may retrieve the user listening activity data from the past as user historical or preference data from storage 108 via network 106. Computing server 104 may determine other radio stations that the user would enjoy based on the analysis of the user's historical or preference data and the current user listening activity data. Computing server 104 may generate a user's profile information based on the content that was being broadcast when the user's listening activity occurred. The user's profile information may also include information related to the user's preferences. Computing server 104 may automatically generate the user's profile information without the user's direct input. Additionally, or alternatively, computing server 104 may receive certain user input to generate the user's profile information. For example, the user may be allowed to set up a profile and select particular categories of topics that the user likes. Computing server 104 may retrieve other users' historical or preference data when the other user's profile information is determined to be similar to the current user's profile information. The user's profile information may include the user's geographic information, age, gender, ethnicity, date of birth, and the music, radio programs, or other radio content that the user routinely listens to.

Computing server 104 may determine information about similar audio content or radio stations from storage 108 based on a comparison of the user's historical or preference data and the information related to the user's current listening activity. Computing server 104 may generate customized audio content recommendations or radio station recommendations based on the information about a single episode of the audio content (e.g., podcast) the user is currently listening to. Computing server 104 may generate customized audio content or radio station recommendations based on the radio station the user routinely tunes in the present and/or past.

In other examples, computing server 104 may generate a list of recommended radio stations that broadcast audio content produced by the same host. For example, computing server 104 may determine that the user would enjoy listening to other podcasts produced by the same host. If a user enjoys listening to radio talk shows related to football, computing server 104 may generate a list of radio stations that may play other radio talk shows that discuss football. Computing server 104 may determine whether a user who likes to listen to a radio talk show related to football may be interested in listening to crossover audio content centered around broader topics such as other sports.

Computing server 104 may utilize a machine learning model trained with various listening activity data of a plurality of users. The machine learning model may include unsupervised learning, linear regression, logistic regression, Naïve Bayes, SVM algorithm, neural network, deep learning and KNN, etc. Computing server 104 may use audio recognition techniques to identify certain keywords spoken by a host of a radio program. Computing server 104 may use the machine learning model to determine related or similar keywords and/or topics based on the identified keywords. Computing server 104 may also determine similar radio programs that focus on the determined keywords and/or topics.

Computing server 104 may retrain the machine learning model with feedback data input by the users and iteratively refine the list of recommended similar audio content or radio stations to generate more accurate recommendations more effectively. For example, computing server 104 may allow the user to accept or decline each item in the list of the recommended similar audio content or radio stations. If the user declines partier audio content or radio stations that computing server 104 recommended, such information may be used to update the machine learning model.

In some examples, computing server 104 may continually provide the list of radio stations receivable by radio receiver 110. If the location of the user device or radio receiver 110 changes to a location in a different town or state, radio receiver 110 may receive OTA audio signals from different radio stations. Computing server 104 may determine the list of the receivable radio stations and provide the respective radio program data for each radio station in real-time or at a preconfigured time interval (e.g. every five (5) or ten (10) minutes) as vehicle 112 continues to travel or the location of the radio receiver 110 continues to change.

In some examples, computing server 104 may receive a request from the radio receiver 110 to send the generated audio content recommendations or radio station recommendations to radio receiver 110. Computing server 104 may also send the notification to the user's smartphone or smartwatch. In the example of the radio programs related to football, computing server 104 may send the recommendation for the radio stations and the scheduled broadcast time for other radio programs that discuss football several times throughout the day. Computing server 104 may send the recommendation to a display screen equipped in vehicle 112 and allow the user to interact with the display screen. For example, the user may select or deselect one or more recommended radio stations from the display screen to accept or decline. Any interaction or feedback input by the user may be stored in storage 108. Computing server 104 may use the stored input data as the user's historical or preference data. Computing server 104 may receive a request from the user for a customized recommendation using the above display screen.

According to some examples, computing server 104 may analyze the user's facial expression to generate the audio content or radio station recommendation. User's vehicle 112 may be equipped with one or more camera sensors configured to continually monitor the face of the user while driving and may send the facial expression information to computing server 104 for analysis. Computing server 104 may determine that the user's facial expression indicates that the user is interested in a specific radio program broadcast by a radio station received by the user device. Computing server 104 may use such information to generate a recommendation for similar radio programs. In other examples, computing server 104 may be communicably coupled to a display screen, sound controller, or music player equipped in vehicle 112. Computing server 104 may detect a change in volumes controlled by the user in vehicle 112 to determine whether the user is trying to listen carefully to a particular radio program. If the user turns on the volume of the radio talk show hosted by a particular host, computing server 104 may determine that the user may be interested in other audio content hosted by the same host.

In other examples, computing server 104 may receive biometric information about the user such as heart rate or temperatures measured by the user's wearable devices and determine the user's mood or emotions. Computing server 104 may also analyze the received biometric information to determine whether the user is enjoying the radio program currently being played.

Computing server 104 may also communicate with a speaker or microphone system equipped in vehicle 112 and collect the audio information from the user. Such audio information may include the user's voice captured when the user is expressing the user's emotions using words when listening to a particular radio program.

Computing server 104 may receive the above information from a group of individuals sitting in vehicle 112 collectively. For example, if one or more individuals in vehicle 112 express vocal expressions (e.g. excitement, shouting, etc.) when listening to a particular radio show, computing server 104 may determine that the entire group would be interested in similar radio shows and recommend such radio shows for the entire group.

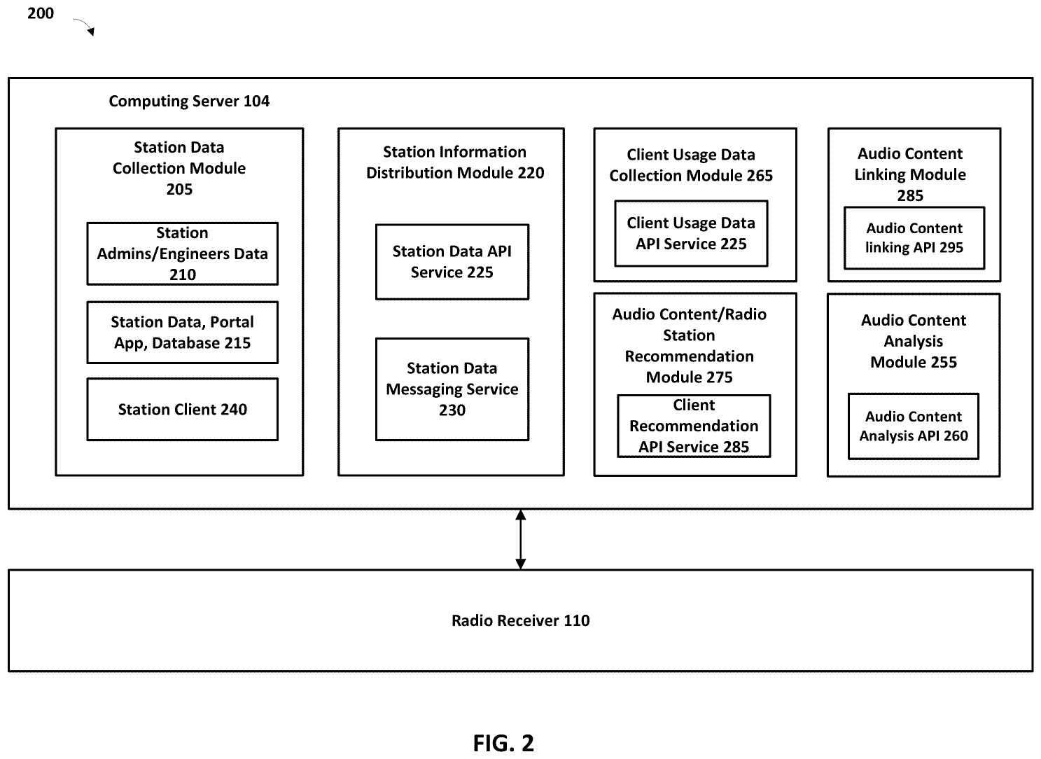

FIG. 2 depicts a block diagram illustrating example components of music and radio programming recommendation system. Computing server 104 may comprise station data collection module 205, station information distribution module 220, client usage data collection module 265, and podcast or radio station recommendation module 275. Computing server 104 may communicate with radio receiver 110 to receive user listening activity data and send audio content recommendations or radio station recommendations as described in connection with FIG. 1. Station data collection module 205 may include station admin or engineer data 210, station data, portal app and database 214 and station client 240. Station information distribution module 220 may comprise station data API service 225 and station data messaging service 230. Client usage data collection module 265 may include client usage data API service 225. Audio content or radio station recommendation module 275 may include client recommendation API service 285.

Station data collection module 205 may be configured to keep track of what is being played by each of a plurality of radio stations via an API. Station data collection module 205 may collect various identification information that can describe a particular radio station from station admin or engineer data 210. Station admin or engineer data 210 may include various information about the radio station such as logo, slogan, themes, or genres of music that the radio station broadcasts. The above identification may be stored in station data, portal app database 215. Station client 240 may include detailed information about podcasts, associated hosts, producers, schedules of each radio program, etc.

Station information distribution module 220 may be configured to transmit radio station data to radio receiver 110 via station data API service 225. Station data API service 225 may provide the radio station data, and associated metadata, podcasts, and program information of each radio station stored in station data, portal app, database 215 to radio receiver 110. Station data messaging service 230 may provide information as to whether the radio station has a new radio program or has changed the themes of the audio content that the respective radio station routinely broadcasts, etc., such that the user can be notified of such changes on a display screen of radio receiver 110.

Client usage data collection module 265 may be configured to collect client usage data via client usage data API service 225. Client usage data may include information related to the identification of the radio station, and its radio program that the user is currently listening to. Client usage data may include historical usage data related to the user's past listening activities. Client usage data API service 225 may also keep track of the altitude or longitude information of radio receiver 110 to identify any available radio coverage in the vicinity.

Audio content or radio station recommendation module 275 may be configured to send audio content or radio station recommendations using client recommendation API service 285. Client recommendation API service 285 may be capable of communicating with radio station 102 via wireless IP. According to some examples, radio station 102 may directly transmit the audio content or radio station recommendations to radio receiver 110. Client recommendation API service 285 may also directly communicate with radio receiver 110 via wireless or cellular IP. Client recommendation API service 285 may change the recommendations as the client usage data received by client usage data collection module 265 changes. For example, if the user tunes radio receiver 110 to a different station that broadcasts different radio talk shows centered around different topics, client recommendation API service 285 may update the recommendation and send the updated recommendation to radio receiver 110 in real-time or near real-time.

Audio content linking module 285 may include audio content linking API service 295. Audio content linking API service 295 may provide one or more hyperlinks for accessing additional episodes, highlights, or any other radio talk shows or podcasts hosted by the same host that can be accessed using the Internet. For example, if a user often listens to a particular radio program that discusses a particular subject matter, such as football, audio content linking API service 295 may identify additional radio talk shows or podcast episodes of podcasts that more generally focus on football. In some examples, audio content linking API service 295 may recommend other radio talk shows or podcasts based on deeper analyses of the content of the currently played radio talk shows or podcasts. For example, audio content linking API service 295 may identify a podcast with pro-football-team content or anti-football-team content and provide hyperlinks for either podcast based on the user's preference data.

Audio content analysis module 255 may include audio content analysis API 260. Audio content analysis API 260 may use machine learning models to identify specific keywords used in the audio content. For example, audio content analysis API 260 may utilize voice recognition techniques to recognize certain keywords spoken by the host of the radio talk show or guests such as football, soccer, leagues, names of the teams, etc. Audio content analysis module 255 may compare the identified keywords to the keywords contained in stored content taxonomy such as interactive advertising bureaus (IAB) content taxonomy. IAB taxonomy may contain standard classifications that publishers and brand companies use to categorize web content for effective targeting. Audio content analysis module 255 may identify classifications corresponding to the identified keywords. Audio content analysis module 255 may further determine specific topics or themes based on the classifications. Audio content analysis module 255 may send the determined topics or themes to audio content or radio station recommendation module 275. Audio content or radio station recommendation module 275 may determine radio programs or supplemental content streamed on the Internet to generate customized recommendations for the user.

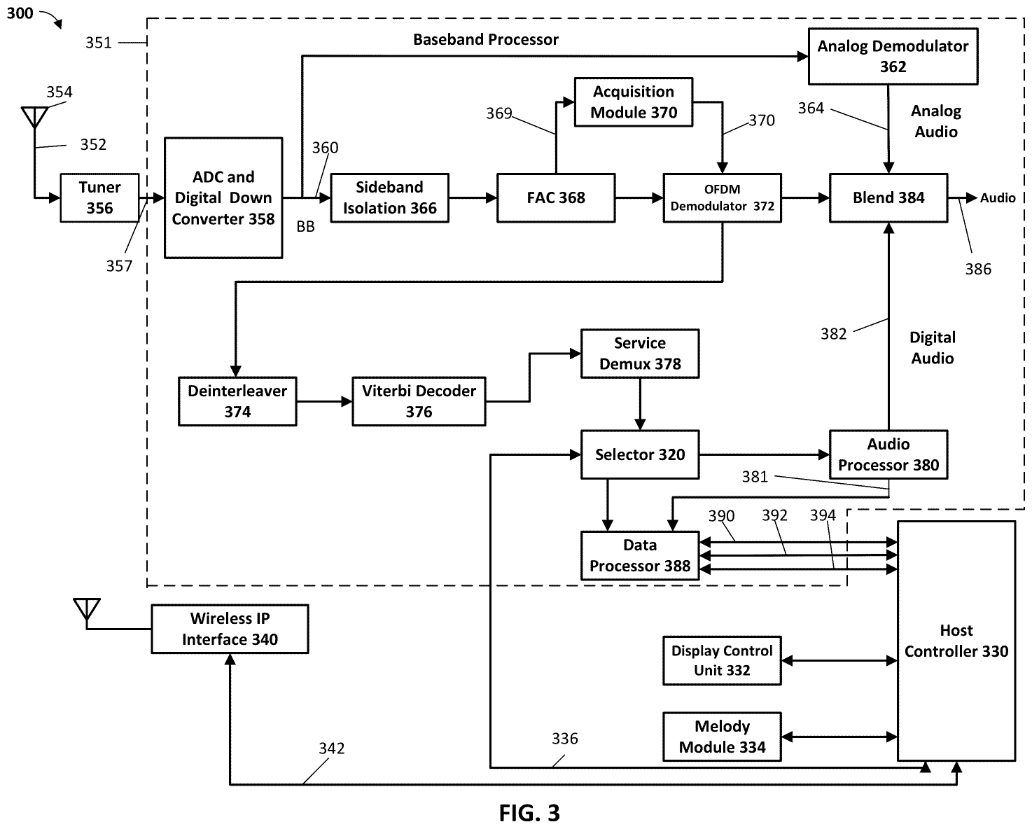

FIG. 3 depicts a block diagram illustrating an example radio receiver 300. In some examples, radio receiver 300 may include an in-band on-channel (IBOC) digital radio receiver. An IBOC implementation of digital radio broadcasting and reception is described in U.S. Pat. No. 8,676,114, which is incorporated herein by reference in its entirety. To implement the approaches of the instant disclosure, radio receiver 300 includes a wireless IP interface 340 for audio content or radio station recommendations via wireless IP and other components for receiving over-the-air radio broadcast signals. The wireless IP interface 340 and host controller 330 may be collectively referred to as a wireless internet protocol hardware communication module.

It should be understood that radio receiver 300 of FIG. 3 is merely an example. In some examples, radio receiver 300 may be equivalent to radio receiver 110 as depicted in FIG. 1. In other examples, the radio broadcast receiver system 110 depicted in FIG. 1 does not use radio receiver 300 of FIG. 3 and instead uses other hardware and/or software for implementing both an Internet receiver and a radio receiver.

While only certain components of radio receiver 300 are shown for exemplary purposes, it should be apparent that the receiver may comprise a number of additional components. The additional components may be distributed among a number of separate enclosures having tuners and front-ends, hosts, remote controls, various input/output devices, and other components. The exemplary receiver includes a tuner 356 that has an input 352 connected to an antenna 354. Antenna 354, tuner 356, and baseband processor 351 may be collectively referred to as an over-the-air radio broadcast hardware communication module.

Within the baseband processor 351, the intermediate frequency signal 357 from the tuner 356 is provided to an analog-to-digital converter and digital down converter 358 to produce a baseband signal at output 360 comprising a series of complex signal samples. The signal samples are complex in that each sample comprises a “real” component and an “imaginary” component. An analog demodulator 362 demodulates the analog modulated portion of the baseband signal to produce an analog audio signal on line 364. The digitally modulated portion of the sampled baseband signal is next filtered by sideband isolation filter 366, which has a passband frequency response comprising the collective set of subcarriers f1-fn present in the received orthogonal frequency-division multiplexing (OFDM) signal. First adjacent canceller (FAC) 368 suppresses the effects of a first-adjacent interferer. Complex signal 369 is routed to the input of acquisition module 370, which acquires or recovers OFDM symbol timing offset/error and carrier frequency offset/error from the received OFDM symbols as represented in received complex signal 369. Acquisition module 370 develops a symbol timing offset Δt and carrier frequency offset Δf, as well as status and control information. The signal is then demodulated (block 372) to demodulate the digitally modulated portion of the baseband signal.

Then the digital signal is de-interleaved by a de-interleaver 374 and decoded by a Viterbi decoder 376. Viterbi decoder 376 may include any decoder that uses the Viterbi algorithm for decoding a bitstream that includes convolution codes. A service de-multiplexer 378 separates main and supplemental program signals from data signals.

The example radio receiver 300 of FIG. 3 also includes a wireless IP interface 340 for receiving data via wireless Internet. The wireless IP interface 340 is managed by the host controller 330. As illustrated in FIG. 3, the wireless IP interface 340 and the host controller 330 are coupled via line 342, and data transmitted between the wireless IP interface 340 and the host controller 330 is sent over line 342. A component may select data received via the wireless IP interface 340 for rendering. For example, selector 320 may connect to host controller 330 via line 336 to select specific data received from the wireless IP interface 340.

The data for rendering may include audio content or radio station recommendations, as described herein, and may be rendered at substantially the same time that primary programming content received over-the-air (e.g., audio received via an over-the-air radio broadcast signal) is rendered.

In some examples, a component (e.g., the selector 320) of the receiver 300 may make a request to an API server for recommendations for similar audio content such as radio talk shows or podcasts or a list of receivable radio stations that broadcast similar podcasts or radio talk shows, e.g., via the wireless IP interface 340, which communicates with the host controller 330, to send a request for the recommendations. An audio processor 380 processes received signals to produce an audio signal on line 382 and MPSD/SPSD 381. In some examples, analog and main digital audio signals are blended as shown in block 384, or the supplemental program signal is passed through, to produce an audio output on line 386. A data processor 388 processes received data signals and produces data output signals on lines 390, 392, and 394. The data lines 390, 392, and 394 may be multiplexed together onto a suitable bus such as an I2c, SPI, UART, or USB. The data signals can include, for example, data representing the recommendations to be rendered at the receiver.

The host controller 330 receives and processes the data signals. The host controller 330 comprises a microcontroller that is coupled to the display control unit (DCU) 332 and memory module 334. Any suitable microcontroller could be used such as an 8-bit RISC microcontroller, an advanced RISC machine 32-bit microcontroller, or any other suitable microcontroller. Additionally, a portion or all of the functions of the host controller 330 could be performed in a baseband processor (e.g., the processor 380 and/or data processor 388). The DCU 332 comprises any suitable input/output (I/O) processor that controls the display, which may be any suitable visual display such as an LCD or LED display. In certain examples, the DCU 332 may also control user input components via a touch-screen display. In some examples, DCU 332 may be configured to allow the user to accept or decline one or more audio content or radio stations recommended by computing server 104 of FIG. 1. In other examples, the host controller 330 may also control user input from a keyboard, dials, knobs, or other suitable inputs. The memory module 334 may include any suitable data storage medium such as RAM, Flash ROM (e.g., an SD memory card), and/or a hard disk drive. In some examples, the memory module 334 may be included in an external component that communicates with the host controller 330 such as a remote control.

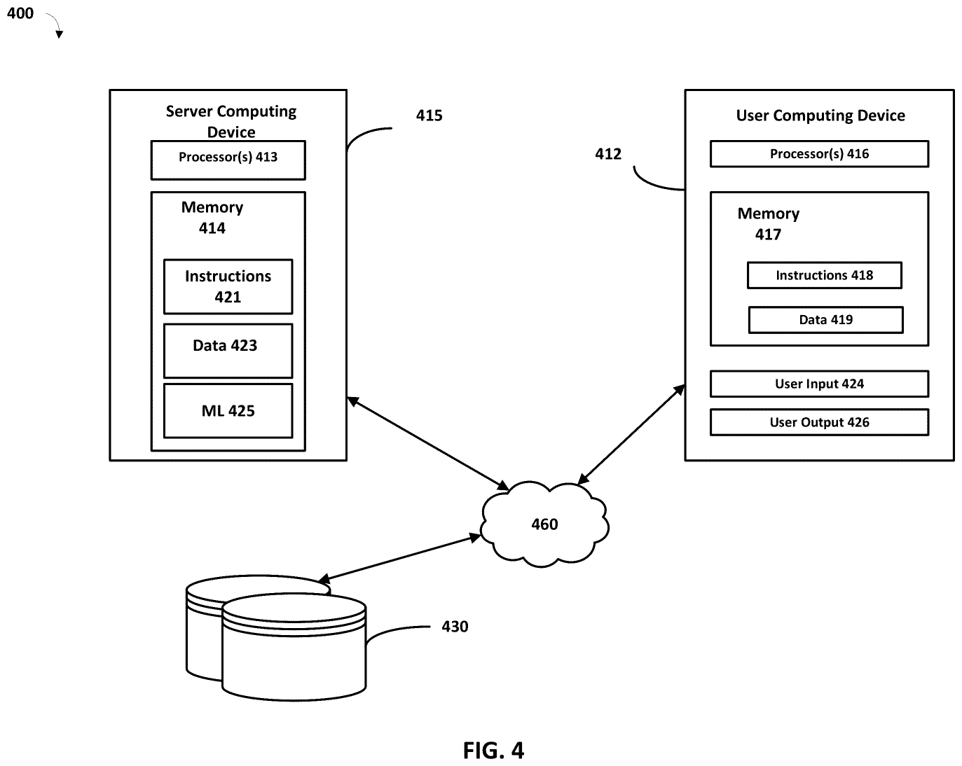

FIG. 4 depicts a block diagram illustrating example components of a server system. User computing device 412 may include a radio receiver with a display that can be adapted to display recommended radio stations or audio content. Server computing device 415 may be a component of computing server 104 illustrated in FIG. 1. Server computing device 415 may provide music or radio station recommendations to the user computing device 412 for display. Server computing device 415 may further receive and analyze the information related to the user listening activities. For example, the information related to the user listening activities includes information as to audio content or radio programs that the user listens to for a particular period of time. In some examples, the information may also include the geographic location of the user device. User computing device 412 may transmit a request from the user to server computing device 415 for audio content or radio station recommendations based on the user's preferred radio talk shows and information related to the talk show's topics, hosts and/or particular time of the day for listening. The audio content or radio station recommendations may be displayed on a display of user computing device 412.

User computing device 412 and the server computing device 415 can be communicatively coupled to one or more storage devices 430 over a network 460. The storage device(s) 430 can be a combination of volatile and non-volatile memory and can be at the same or different physical locations than the computing devices 412, 415. For example, the storage device(s) 430 can include any type of non-transitory computer-readable medium capable of storing information, such as a hard-drive, solid state drive, tape drive, optical storage, memory card, ROM, RAM, DVD, CD-ROM, write-capable, and read-only memories.

The server computing device 415 can include one or more processors 413 and memory 414. Memory 414 can store information accessible by the processor(s) 413, including instructions 421 that can be executed by the processor(s) 413. Memory 414 can also include data 423 that can be retrieved, manipulated, or stored by the processor(s) 413. Memory 414 can further include machine learning model 425. Machine learning model 425 may be trained to identify recommendable audio content or radio stations based on the user's historical and/or preference data.

Memory 414 can be a type of non-transitory computer-readable medium capable of storing information accessible by the processor(s) 413, such as volatile and non-volatile memory. The processor(s) 413 can include one or more central processing units (CPUs), graphic processing units (GPUs), field-programmable gate arrays (FPGAs), and/or application-specific integrated circuits (ASICs), such as tensor processing units (TPUs).

Instructions 421 can include one or more instructions that when executed by the processor(s) 413, cause the one or more processors to perform actions defined by the instructions. Instructions 421 can be stored in object code format for direct processing by the processor(s) 413, or in other formats including interpretable scripts or collections of independent source code modules that are interpreted on demand or compiled in advance. Instructions 421 can include instructions for implementing processes consistent with aspects of this disclosure. Such processes can be executed using the processor(s) 413, and/or using other processors remotely located from the server computing device 415.

Data 423 can be retrieved, stored, or modified by the processor(s) 413 in accordance with instructions 421. Data 423 can be stored in computer registers, in a relational or non-relational database as a table having a plurality of different fields and records, or as JSON, YAML, proto, or XML documents. Data 423 can also be formatted in a computer-readable format such as, but not limited to, binary values, ASCII, or Unicode. Moreover, data 423 can include information sufficient to identify relevant information, such as numbers, descriptive text, proprietary codes, pointers, references to data stored in other memories, including other network locations, or information that is used by a function to calculate relevant data.

User computing device 412 can also be configured similar to the server computing device 415, with one or more processors 416, memory 417, instructions 418, and data 419. The user computing device 412 can also include a user output 426, and a user input 424. The user input 424 can include any appropriate mechanism or technique for receiving input from a user, such as a keyboard, mouse, mechanical actuators, soft actuators, touchscreens, microphones, and sensors.

Server computing device 415 can be configured to transmit data to the user computing device 412, and the user computing device 412 can be configured to display at least a portion of the received data on a display implemented as part of the user output 426. The user output 426 can also be used for displaying an interface between the user computing device 412 and the server computing device 415. The user output 426 can alternatively or additionally include one or more hosts, transducers, or other audio outputs, a haptic interface or other tactile feedback that provides non-visual and non-audible information to the platform user of the user computing device 412.

Although FIG. 4 illustrates the processors 413, 416 and the memories 414, 417 as being within the computing devices 415, 412, components described in this specification, including the processors 413, 416 and the memories 414, 417 can include multiple processors and memories that can operate in different physical locations and not within the same computing device. For example, some of the instructions 421, 418 and the data 423, 419 can be stored on a removable SD card and others within a read-only computer chip. Some or all of the instructions and data can be stored in a location physically remote from, yet still accessible by, the processors 413, 416. Similarly, processors 413, 416 can include a collection of processors that can perform concurrent and/or sequential operations. Computing devices 415, 412 can each include one or more internal clocks providing timing information, which can be used for time measurement for operations and programs run by computing devices 415, 412.

The server computing device 415 can be configured to receive requests to process data from the user computing device 412. For example, environment 400 can be part of a computing platform configured to provide a variety of services to users, through various user interfaces and/or APIs exposing the platform services. One or more services may include automatically generating recommendations for similar audio content or radio station based on monitoring of the user's listening activities.

Devices 412, 415 can be capable of direct and indirect communication over network 460. Devices 412, 415 can set up listening sockets that may accept an initiating connection for sending and receiving information. The network 460 itself can include various configurations and protocols including the Internet, World Wide Web, intranets, virtual private networks, wide area networks, local networks, and private networks using communication protocols proprietary to one or more companies. Network 460 can support a variety of short- and long-range connections. The network 460, in addition, or alternatively, can also support wired connections between devices 412, 415, including over various types of Ethernet connection.

Although a single server computing device 415 and user computing device 412 are shown in FIG. 4, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

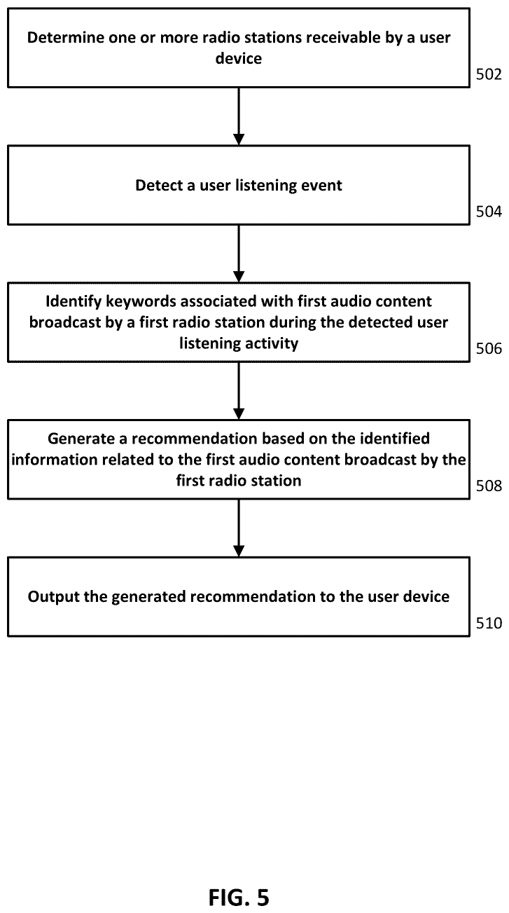

FIG. 5 depicts a flow diagram illustrating a music and radio programming recommendation process. According to block 502, one or more radio stations receivable by a user device are determined. The audio content and radio programming recommendation system can monitor the geographic location of the user device and identify a list of the radio stations receivable by the user device. When the user drives away from one location to another location, the system may keep track of the change in the user device's geographic location and update the list of the radio stations receivable by the user device in real-time or near real-time.

According to block 504, a user listening event is detected. For example, the user listening event can include the user tuning to a particular station, remaining tuned to the particular station for a threshold amount of time, or the like. Additional user listening events can include increasing a volume control while the particular station is being received, visual or audible cues while the particular station is being received (e.g., a verbal “yes” or head nod in response to commentary within a program being received), etc. The system may monitor the user's listening activity when the user device, such as an in-vehicle radio receiver, is tuned to a particular radio station. The system may store the information of the radio station that the user tuned into and identify a radio program or music that the user is currently listening to. The system may store timestamp information for the user's listening event.

According to block 506, keywords related to the first audio content broadcast by a first radio station are identified. The system may determine information related to the audio content that the user is currently listening to. Such information may include, the topic of the radio talk shows or podcasts, associated hosts, the year when the radio talk shows or podcasts were aired, etc. The information may be determined by, for example, machine learning models analyzing audio signals received by the user device. Additionally or alternatively, the information may be determined using other resources, such as a program agenda or other metadata provided by the radio station. In some examples, the information related to the audio content can be determined based on post-processed semantic information obtained from a recording of a previously aired broadcast of the same audio content. The information may be used to generate recommendations for similar types of radio talk shows or podcasts, or other radio talk shows or podcasts hosted by the same host. In some examples, the keywords can be weighted based on factors such as the frequency with which the keywords occur in the received content. Other weighting factors can relate to the user's preference level, such as detected user responses when the content is received. For example, the system may detect through a microphone or camera that the user provides an audible or visual response to portions including some keywords. Such user responses can be used to weight the user's preference for that content.

According to block 508, a recommendation is generated based on the identified information related to the first audio content broadcast by the first radio station. For example, the system may generate a recommendation for similar audio content (e.g. podcast) based on the information related to the first audio content, such as by matching the keywords detected from the first audio content to keywords from available podcasts or other programs, In other examples, the system may generate a recommendation for a radio station, such as a station that broadcasts programs having topics related to the detected keywords based on the information related to the first audio content. In some examples, the recommendations can be based on information related to the radio station that broadcasts the first audio content. Such information may include information related to the hosts of radio programs broadcast by the radio station and information related to the content of the other radio programs hosted by the hosts. The system may also recommend similar audio content based on information related to the host associated with the first audio content. In some examples, the system may recommend a video or TV show or documentary focusing on the similar topics available through a streaming service.

In some examples, episode guides and other listings related to the audio content may contain hyperlinks and URLs for allowing access to additional content related to the first audio content. For example, the system may provide one or more URLs containing additional episodes, highlights, or any other podcasts hosted by the same host that can be found on the Internet.

According to block 510, the generated recommendation is output to the user device. In some examples, the output can also identify uniform resource locators (URLs) or other access information for accessing the recommended content. The generated recommendation can be displayed on a screen or other output device, which may be included in the user's vehicle, on the user's portable device such as a laptop, tablet, smartphone, or smartwatch, or on a fixed receiver. The system may allow the user to accept or decline each of the recommendations, or to otherwise provide feedback (e.g., “save for later”, “do not recommend this again”, etc.). Any input provided by the user may be stored and analyzed for generating other recommendations in the future.

The present disclosure describes techniques that may be advantageous in recommending second content specific to the first content received by a user device through over-the-air broadcast signals. By analyzing content received through over-the-air signals, and in some cases detecting user reactions to the content, the system can isolate specific topics and interests that may otherwise not be detectable. For example, if a radio disc jockey tells a short story or joke between songs, such content would typically not be captured in any categorization of the radio station content. Because the present disclosure detects the keywords of the short story or joke, user preferences can account for such content despite its isolated and brief mention.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Although the technology herein has been described with reference to particular examples, it is to be understood that these examples are merely illustrative of the principles and applications of the present technology. It is therefore to be understood that numerous modifications may be made and that other arrangements may be devised without departing from the spirit and scope of the present technology as defined by the appended claims.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A system for audio content and radio programming recommendations, the system comprising:
one or more memories; and
one or more processors in communication with the one or more memories, the one or more processors configured to:
determine one or more radio stations receivable by a user device;
detect a user listening activity;
identify one or more keywords associated with first audio content broadcast by a first radio station during the detected user listening activity;
generate a recommendation for second audio content based on the identified one or more keywords associated with the first audio content; and
output the generated recommendation to the user device.

2. The system of claim 1, wherein the one or more processors are further configured to identify one or more t uniform resource locators (URLs) to access the second audio content.

3. The system of claim 2, wherein the second audio content comprises a podcast, talk show, news program, or visual content.

4. The system of claim 1, wherein the user listening activity includes tuning the user device to a first broadcast channel for the first radio station or remaining on the first broadcast channel for a threshold time period.

5. The system of claim 1, wherein the one or more processors are further configured to retrieve metadata of the first audio content from a database and transmit the metadata to the user device, wherein the metadata includes information related to a subject, host, or date of broadcast.

6. The system of claim 1, wherein the one or more processors are further configured to:
determine the preference data or historical data for a user based on one or more previous listening activities for the user; and
generate the recommendation based on the determined user's preference data or historical data.

7. The system of claim 1, wherein generating the recommendation comprises generating a recommendation for the second audio content based on information related to a host associated with the first audio content.

8. The system of claim 1, wherein the one or more processors are further configured to receive a request from the user for a customized recommendation using the user device.

9. The system of claim 1, wherein the one or more keywords associated with first audio content is identified using a machine learning model.

10. The system of claim 9, wherein the one or more processors are further configured to receive feedback on the generated recommendation and update the machine learning model based on the received feedback using the user device.

11. The system of claim 1, wherein the one or more keywords associated with the first audio content broadcast by the first radio station are identified based on semantic keyword identifications derived from post-processing a previously recorded broadcast of the first audio content.

12. A method for audio content and radio programming recommendations, the method comprising:
determining one or more radio stations receivable by a user device;
detecting a user listening event;
identifying one or more keywords associated with first audio content broadcast by a first radio station during the detected user listening activity;
generating a recommendation for second audio content based on the identified one or more keywords associated with the first audio content; and
outputting the generated recommendation to the user device.

13. The method of claim 12, further comprising identifying one or more Internet URLs to access the second audio content.

14. The method of claim 12, wherein the second audio content comprises a podcast, talk show, news program, or visual content.

15. The method of claim 12, wherein the user listening activity includes tuning the user device to a first broadcast channel for the first radio station or remaining on the first broadcast channel for a threshold time period.

16. The method of claim 12, further comprising retrieving metadata of the first audio content from a database and transmitting the metadata to the user device, wherein the metadata includes information related to a subject, host, or date of broadcast.

17. The method of claim 12, further comprising determining the preference data or historical data for a user based on one or more previous listening activities for the user, and generating the recommendation based on the determined user's preference data or historical data.

18. The method of claim 12, wherein generating the recommendation comprises generating a recommendation for the second audio content based on information related to a host associated with the first audio content.

19. The method of claim 12, further comprising receiving a request from the user for a customized recommendation using the user device.

20. The method of claim 12, wherein the one or more keywords associated with first audio content is identified using a machine learning model.
